(19) United States
(12) Patent Application Publication
(10) Pub. No.: US 2026/0017672 A1
(43) Pub. Date: Jan. 15, 2026

(54) SYSTEMS AND METHODS FOR HANDLING SUPPLY CHAIN CERTIFICATES

(71) Applicant: Dell Products L.P., Round Rock, TX (US)

(72) Inventors: Gordon A. Frye, Westborough, MA (US); Kenneth T. Coker, Firestone, CO (US); Milton Olavo Decarvalho Taveira, Round Rock, TX (US); Chandrashekar Nelogal, Round Rock, TX (US)

(73) Assignee: Dell Products L.P., Round Rock, TX (US)

(21) Appl. No.: 18/770,395

(22) Filed: Jul. 11, 2024

(51) Int. Cl. G06Q 30/018; H04L 9/32

(52) U.S. Cl. CPC G06Q 30/0185; H04L 9/3268

(57) ABSTRACT

Systems and methods for handling supply chain certificates are described. In an illustrative, non-limiting embodiment, an Information Handling System (IHS) may include a processor and a memory coupled to the processor. The memory may store program instructions that, upon execution, cause the IHS to receive a message from a supplier identifying a device. The IHS may verify the device against a Purchase Order (PO) database of an Original Equipment Manufacturer (OEM) and may send encrypted material to the supplier. The supplier may generate a Certificate Signing Request (CSR) for the device comprising the encrypted material. The supplier may receive a digital certificate in response to the CSR and stores the certificate in the device. The system may ensure the authenticity and quality of components throughout the supply chain using cryptographic techniques.

### FIELD

This disclosure relates generally to Information Handling Systems (IHSs), and more specifically, to systems and methods for handling supply chain certificates.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Systems and methods for handling supply chain certificates are described. In an illustrative, non-limiting embodiment, an Information Handling System (IHS) may include a processor and a memory coupled to the processor, the memory having program instructions stored thereon that, upon execution, cause the IHS to receive a message from a supplier, where the message identifies a device; and in response to verification of the device against a Purchase Order (PO) database of an Original Equipment Manufacturer (OEM), send encrypted material to the supplier, where the supplier is configured to generate a Certificate Signing Request (CSR) for the device comprising the encrypted material.

In some cases, to verify the device against the PO database, the program instructions, upon execution, may cause the IHS to determine the device has not been previously processed. The encrypted material may include at least one of: a device serial number, a model number, or a PO number. The supplier may be configured to receive a digital certificate in response to the CSR.

The message may include a message ID indicating an impending digital certificate for the device. Attestation of the digital certificate may indicate the device was made for the OEM. Additionally, or alternatively, attestation of the digital certificate may indicate the device was made for a customer of the OEM.

The digital certificate may include a Security Protocol and Data Model (SPDM) certificate. The supplier may be configured to store the SPDM certificate in slot 0 of the device. The supplier may include a first supplier and a second supplier, the first supplier produces the device, the second supplier produces a device part, the first supplier is configured to forward the encrypted blob to the second supplier, and the second supplier is configured to generate another CSR for the part.

In another illustrative, non-limiting embodiment, a method may include receiving a message from a supplier, where the message identifies a device; and in response to verification of the device against a PO database of an OEM, transmitting an OEM's digital certificate to the supplier, where the supplier is configured to generate a CSR for the device comprising the OEM's digital certificate.

The message may include a message ID indicating an impending Security Protocol and Data Model (SPDM) certificate for the device. The digital certificate may include at least one of: a device serial number, a model number, or a PO number. The supplier may be configured to receive a device's digital certificate in response to the CSR. The supplier may be configured to store the device's digital certificate in slot 1 of the device.

In yet another illustrative, non-limiting embodiment, a hardware memory device may have program instructions stored thereon that, upon execution by a processor of an IHS, cause the IHS to send a message to an OEM, where the message identifies a device; and receive encrypted material from an OEM in response to the OEM's verification of the device against a PO database.

In some cases, the encrypted material may include a digital certificate issued by the OEM. The program instructions, upon execution by the processor, may cause the IHS to generate a CSR for the device comprising the encrypted material.

The processor may be part of a heterogenous computing platform selected from the group consisting of: a System-On-Chip (SoC), a Field-Programmable Gate Array (FPGA), and an Application-Specific Integrated Circuit (ASIC). The heterogenous computing platform may include a Reduced Instruction Set Computer (RISC) processor coupled to the EC via an interconnect, and where the interconnect comprises at least one of: an Advanced Microcontroller Bus Architecture (AMBA) bus, a QuickPath Interconnect (QPI) bus, or a HyperTransport (HT) bus.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS), according to some embodiments.

FIG. 2 is a diagram illustrating an example of a heterogenous computing platform, according to some embodiments.

FIG. 3 is a diagram illustrating an example of a software and firmware architecture of an IHS, according to some embodiments.

FIG. 4 is a flowchart illustrating an example of a method for handling supply chain certificates, according to some embodiments.

FIG. 5 is a diagram illustrating an example of a system for handling supply chain certificates, according to some embodiments.

FIG. 6 is a diagram illustrating an example of a first process flow for handling supply chain certificates, according to some embodiments.

FIG. 7 is a diagram illustrating an example of a second process flow for handling supply chain certificates, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various Input/Output (I/O) devices, such as a keyboard, a mouse, touchscreen, and/or a video display. An IHS may also include one or more buses operable to transmit communications between the various hardware components.

The terms “heterogenous computing platform,” “heterogenous processor,” or “heterogenous platform,” as used herein, refer to an Integrated Circuit (IC) or chip (e.g., a System-On-Chip or “SoC,” a Field-Programmable Gate Array or “FPGA,” an Application-Specific Integrated Circuit or “ASIC,” etc.) containing a plurality of discrete processing circuits or semiconductor Intellectual Property (IP) cores (collectively referred to as “SoC devices” or simply “devices”) in a single electronic or semiconductor package, where each device has different processing capabilities suitable for handling a specific type of computational task. Examples of heterogenous processors include, but are not limited to: QUALCOMM's SNAPDRAGON, SAMSUNG's EXYNOS, APPLE's “A” SERIES, etc., which typically include ARM core(s).

As used herein, the term “certificate” or “digital certificate” refers to a digital document used to verify the identity of entities and ensure secure communication. A certificate typically includes a public key and identifying information, and it is issued by a trusted Certificate Authority (CA). Certificates enable entities to authenticate each other and establish encrypted connections, ensuring data integrity and confidentiality. A type of digital certificate is the X.509 certificate, which is widely used in various security protocols, including SSL/TLS for secure web browsing and S/MIME for secure email communication.

A “CA” is a trusted entity responsible for issuing digital certificates. The CA verifies the identity of entities requesting certificates and signs the certificates with its private key, establishing a chain of trust. The CA's public key is used by verifiers to validate the certificates issued by the CA.

A Certificate Signing Request (CSR) is a command, message, or a block of encoded text that is given to a CA when applying for a digital certificate. It typically includes the public key for which the certificate should be issued, along with identifying information such as the organization name, common name (domain name), locality, and country. The CA uses the CSR to create a digital certificate that matches the private key associated with the public key in the CSR.

Modern IHSs often include multiple components (e.g., processors, memories, Graphics Processing Units (GPUs), storage devices, network controllers, power supply, fan controllers, Input/Output (I/O) controllers, sensors, etc.), each requiring individual verification to ensure security and integrity. These components typically possess their own certificates issued by respective authorities. The verification process involves validating these certificates to establish the authenticity and trustworthiness of each component.

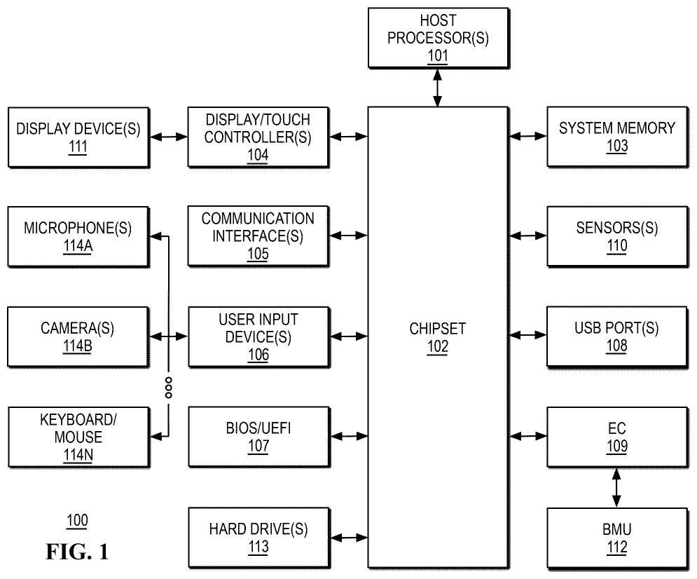

FIG. 1 is a block diagram of examples of components of IHS 100, according to some embodiments. As shown, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 105 to enable communications between IHS 100 and various wired and/or wireless networks, such as ETHERNET, WIFI, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 105 may be used to communicate with peripherals devices (e.g., BT speakers, headsets, etc.). Moreover, communication interface(s) 105 may be coupled to chipset 102 via a Peripheral Component Interconnect Express (PCIe) bus, or the like. Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 may provide video or display signals to one or more display device(s) 111.

Display device(s) 111 may include Liquid Crystal Display (LCD), Light Emitting Diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may operate as a single continuous display, rather than two discrete displays.

Chipset 102 may provide host processor(s) 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more USB ports 108, to which one or more peripheral devices may be coupled (e.g., integrated or external webcams, microphones, speakers, etc.). Chipset 102 may further provide host processor(s) 101 with access to one or more hard disk drives, solid-state drives, optical drives, or other removable media drives 113.

Chipset 102 may also provide access to one or more user input devices 106, for example, using a super I/O controller or the like. Examples of user input devices 106 include, but are not limited to, microphone(s) 114A, camera(s) 114B, and keyboard/mouse 114N. Other user input devices 106 may include a touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105). In some cases, chipset 102 may also provide access to one or more user output devices (e.g., video projectors, paper printers, 3D printers, loudspeakers, audio headsets, Virtual/Augmented Reality or “VR/AR” devices, etc.).

In certain embodiments, chipset 102 may further provide an interface for communications with one or more hardware sensors 110. Sensor(s) 110 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), accelerometer, etc.

Basic Input/Output System (BIOS)/Unified Extensible Firmware Interface (UEFI) 107 is coupled to chipset 102. In some situations, the terms “BIOS” and “UEFI” may be used interchangeably. In operation, BIOS/UEFI 107 provides an abstraction layer that allows a host OS to interface with certain hardware components utilized by IHS 100.

When IHS 100 is powered on, host processor(s) 101 may utilize program instructions of BIOS/UEFI 107 to initialize and test hardware components coupled to IHS 100, and to load host OS 312 for use by IHS 100. As used herein, the term “pre-boot” refers to the period of time, processes, and/or environment between the initialization of host processor(s) 101 and its taking over by host OS 312, after host OS 312 is loaded and operational.

Through a hardware abstraction layer provided by BIOS/UEFI 107, software stored in system memory 103 and executed by host processor(s) 101 may interface with certain I/O devices that are coupled to IHS 100.

Embedded Controller (EC) 109 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as operating chassis buttons and/or switches (e.g., power button, laptop lid switch, etc.), receiving and processing thermal measurements (e.g., performing cooling fan control, CPU and GPU throttling, and emergency shutdown), controlling indicator Light-Emitting Diodes or “LEDs” (e.g., caps lock, scroll lock, num lock, battery, ac, power, wireless LAN, sleep, etc.), managing a battery charger and a battery, enabling remote management, diagnostic tests (or “diagnostics”), remediation over an OOB or sideband network, etc.

Unlike other devices in IHS 100, EC 109 may be operational from the time IHS 100 is first powered on, before other devices are fully running or even powered. As such, EC 109 firmware may be responsible for interfacing with a power adapter to manage the various power states that may be supported by IHS 100. Power operations of the EC 109 may also provide other components of the IHS 100 with power status information for the IHS, such as whether IHS 100 is operating from battery power or is plugged into an AC power source. Firmware instructions utilized by EC 109 may be used to manage other core operations of IHS 100 (e.g., turbo modes, maximum operating clock frequencies of certain components, etc.).

From the perspective of users, IHS 100 may appear to be either “on” or “off,” without any other detectable power states. In some embodiments, however, an IHS 100 may support multiple power states that may correspond to the states defined in the Advanced Configuration and Power Interface (ACPI) specification, such as: S0, S1, S2, S3, S4, S5, and G3.

EC 109 may implement operations for detecting certain changes to the physical configuration or posture of IHS 100 (such as a laptop computer). For instance, when IHS 100 as a 2-in-1 laptop/tablet form factor, EC 109 may receive inputs from a lid position or hinge angle sensor 110, and may use those inputs to determine: whether the two sides of IHS 100 have been latched together to a closed position or a tablet position, the magnitude of a hinge or lid angle, etc. In response to these changes, EC 109 may enable or disable certain features of IHS 100 (e.g., front or rear facing camera, etc.).

In this manner, EC 109 may identify any number of IHS physical postures, including, but not limited to: laptop, stand, tablet, or book. For example, when an integrated display 111 of IHS 100 is open with respect to a horizontal, face-up position of an integrated keyboard, EC 109 may determine IHS 100 to be in a laptop posture. When an integrated display 111 of IHS 100 is open with respect to a horizontal keyboard portion, but the keyboard is facing down (e.g., its keys are against the top surface of a table), EC 109 may determine IHS 100 to be in a kickstand posture. When the back of an integrated display 111 is closed against the back of the keyboard portion of an IHS, EC 109 may determine IHS 100 to be folded in a tablet posture. When IHS 100 has two integrated displays 111 that are open side-by-side (e.g., in a hybrid laptop with displays in both panels), EC 109 may determine an IHS 100 to be in a book posture. When an IHS 100 is determined to be in a book posture, EC 109 may also determine if the display(s) 111 of IHS 100 are arranged in a landscape or portrait orientation, relative to the user.

In some implementations, EC 109 may be installed as part of a Trusted Execution Environment (TEE) component to the motherboard of IHS 100. As a component with hardware root-of-trust (ROT), EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC 109 may later recalculate a hash value based on instructions and settings loaded for use by a hardware component of IHS 100 and may compare the calculated value against the reference hash value to determine if any modifications have been made to the component, thus indicating that the component has been compromised. As such, EC 109 may validate the integrity of hardware and software components installed in IHS 100.

In some embodiments, EC 109 may provide an OOB (Out-Of-Band) or sideband channel that allows an Information Technology Decision Maker (ITDM) or Original Equipment Manufacturer (OEM) to manage various settings and configurations of an IHS 100. OOB is used in contradistinction with “in-band” communication channels that operate only after networking 105 other interfaces of the IHS have been initialized, and the OS of the IHS has been successfully booted.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 112 may be coupled to EC 109 and it may include, for example, an Analog Front End (AFE), storage (e.g., non-volatile memory), and a microcontroller. In some cases, BMU 112 may be configured to collect and store information, and to provide that information to EC 109.

Examples of information collectible by BMU 112 may include, but are not limited to: operating conditions (e.g., battery operating conditions including battery state information such as battery current amplitude and/or current direction, battery voltage, battery charge cycles, battery state of charge, battery state of health, temperature, battery usage data such as charging and discharging data; and/or IHS operating conditions such as processor operating speed data, system power management and cooling system settings, state of “system present” pin signal), environmental or context information (e.g., such as ambient temperature, relative humidity, system geolocation measured by GPS or triangulation, time and date, etc.), etc.

In various embodiments, EC 109 may be coupled (e.g., via a GPIO pin) to any of a plurality of IHS components including, but not limited to: a fan, a cable, a battery, a temperature sensor, or a display. Moreover, EC 109 may be configured to perform or trigger the performance of any number of diagnostic operations for any of these components. For example, in some cases EC 109 may be configured to request that display 111 perform a Built-In-Self-Test (BIST) and to return BIST results to EC 109 upon completion. In other cases, however, EC 109 may itself run the diagnostic operation.

In some embodiments, IHS 100 may not include all components shown in FIG. 1. In other embodiments, IHS 100 may include other components in addition to those shown in FIG. 1. Furthermore, some components illustrated as separate components in FIG. 1 may instead be integrated with other components, such that all or a portion of the operations executed by the illustrated components may instead be executed by the integrated component.

For instance, in various embodiments, host processor(s) 101 and/or other components shown in FIG. 1 (e.g., chipset 102, display controller(s) 104, communication interface(s) 105, EC 109, etc.) may be replaced by devices within a heterogenous computing platform. As such, IHS 100 may assume different form factors including, but not limited to: servers, workstations, desktops, laptops, appliances, video game consoles, tablets, smartphones, etc.

Historically, IHSs with desktop and laptop form factors have had conventional host OSs executed on INTEL or AMD's “x86”-type processors. Other types of processors, such as ARM processors, have been used in smartphones and tablet devices, which typically run thinner, simpler, and/or mobile OSs (e.g., ANDROID, IOS, WINDOWS MOBILE, etc.). More recently, however, IHS manufacturers have started producing fully-fledged desktop and laptop IHSs equipped with ARM-based, heterogenous computing platforms. Accordingly, host OSs (e.g., WINDOWS on ARM) have been developed to provide users with a familiar OS experience on those platforms.

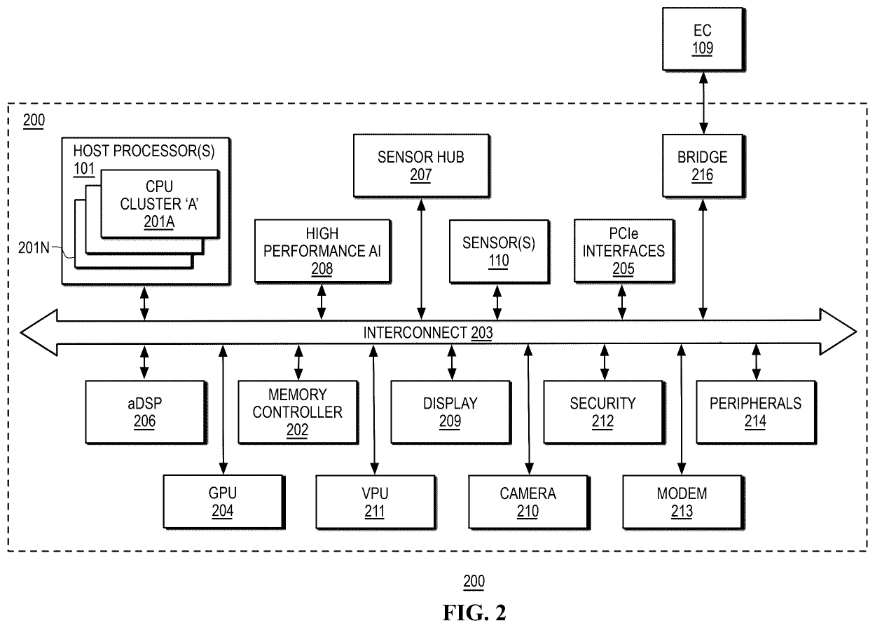

FIG. 2 is a diagram illustrating an example of heterogenous computing platform 200 which may be implemented as part of IHS 100 and/or it may replace certain components shown in FIG. 1 (e.g., host processor(s) 101)). In various embodiments, heterogenous computing platform 200 may be implemented as one or more SoCs, FPGAs, ASICs, or the like.

Heterogenous computing platform 200 may include one or more discrete and/or segregated devices or components, each having a different set of processing capabilities suitable for handling a particular type of computational task. When each device in platform 200 is tasked with executing only the types of computational tasks that it is specifically designed to execute, the overall power consumption of heterogenous computing platform 200 is reduced.

In various implementations, some of the devices in heterogenous computing platform 200 may include their own microcontroller(s) or core(s) (e.g., ARM core(s)) and corresponding firmware. In some cases, a device in platform 200 may also include its own hardware-embedded accelerator (e.g., a secondary or co-processing core coupled to a main core). Each device in heterogenous computing platform 200 may be accessible through a respective Application Programming Interface (API). Additionally, or alternatively, some devices in heterogenous computing platform 200 may execute their own OS. Additionally, or alternatively, one or more of the devices of heterogenous computing platform 200 may be virtual devices.

In the embodiment illustrated in FIG. 2, heterogenous computing platform 200 includes CPU clusters 201A-N that may correspond to system processor(s) 101, and that are intended to perform general-purpose computing operations. Each of CPU clusters 201A-N may include one or more processing cores and cache memories. In operation, CPU clusters 201A-N are available and accessible to the IHS's host OS 312 (e.g., WINDOWS on ARM) and other applications executed by IHS 100.

CPU clusters 201A-N may be coupled to memory controller 202 via internal interconnect fabric 203. Memory controller 202 may be responsible for managing system memory access for all of devices connected to internal interconnect fabric 203, which may include any communication bus suitable for inter-device communications within an SoC (e.g., Advanced Microcontroller Bus Architecture or “AMBA,” QuickPath Interconnect or “QPI,” HyperTransport or “HT,” etc.).

Devices coupled to internal interconnect fabric 203 may communicate with each other and with a host OS executed by CPU clusters 201A-N. In some cases, devices 209-211 may be coupled to internal interconnect fabric 203 via a secondary interconnect fabric (not shown). A secondary interconnect fabric may include any bus suitable for inter-device and/or inter-bus communications within an SoC.

GPU 204 produces graphical or visual content and communicates that content to a monitor or display of IHS 100 for rendering. In some embodiments, display engine or controller 209 may be designed to perform additional video enhancement operations. In operation, display engine 209 may implement procedures for providing the output of GPU 204 as a video signal to one or more external displays coupled to IHS 100 (e.g., display device(s) 111). PCIe interfaces 205 provide an entry point into any additional devices external to heterogenous computing platform 200 that have a respective PCIe interface (e.g., graphics cards, USB controllers, etc.).

Audio Digital Signal Processor (aDSP) 206 is a device designed to perform audio and speech operations and to perform in-line enhancements for audio input(s) and output(s). Examples of audio and speech operations include, but are not limited to: noise reduction, echo cancellation, directional audio detection, wake word detection, muting and volume controls, filters and effects, etc. In operation, input and/or output audio streams may pass through and be processed by aDSP 206, which can send the processed audio to other devices on internal interconnect fabric 203 (e.g., CPU clusters 201A-N).

In some embodiments, aDSP 206 may be configured to process one or more of heterogenous computing platform 200's sensor signals (e.g., gyroscope, accelerometer, pressure, temperature, etc.), low-power vision or camera streams (e.g., for user presence detection, onlooker detection, etc.), or battery data (e.g., to calculate a charge or discharge rate, current charge level, etc.).

Camera device 210 includes an Image Signal Processor (ISP) configured to receive and process video frames captured by a camera coupled to heterogenous computing platform 200 (e.g., in the visible and/or infrared spectrum). Video Processing Unit (VPU) 211 is a device designed to perform hardware video encoding and decoding operations, thus accelerating the operation of camera 210 and display/graphics device 209. VPU 211 may be configured to provide optimized communications with camera device 210 for performance improvements.

Sensor hub 207 may include AI capabilities designed to consolidate information received from other devices in heterogenous computing platform 200, process context and/or telemetry data streams, and provide that information to: (i) a host OS, (ii) other applications, and/or (iii) other devices in platform 200. In collecting data, sensor hub 207 may include General-Purpose Input/Output (GPIOs) that provide Inter-Integrated Circuit (I²C), Improved I²C (I³C), Serial Peripheral Interface (SPI), Enhanced SPI (eSPI), and/or serial interfaces to receive data from sensors (e.g., sensors 110, camera 210, peripherals 214, etc.). Sensor hub 207 may include a low-power core configured to execute small neural networks and specific applications, such as contextual awareness and other enhancements.

High-performance AI device 208 is a significantly more powerful processing device than sensor hub 207, and it may be designed to execute multiple complex AI algorithms and models concurrently (e.g., Natural Language Processing, speech recognition, speech-to-text transcription, video processing, gesture recognition, user engagement determinations, etc.). For example, high-performance AI device 208 may include a Neural Processing Unit (NPU), Tensor Processing Unit (TPU), Neural Network Processor (NNP), or Intelligence Processing Unit (IPU), and it may be designed specifically for AI and Machine Learning (ML), which speeds up the processing of AI/ML tasks while also freeing processor(s) 101 to perform other tasks. Using such capabilities, one or more devices of heterogenous computing platform 200 (e.g., GPU 204, aDSP 206, sensor hub 207, high-performance AI device 208, VPU 211, etc.) may be configured to execute one or more AI model(s), simulation(s), and/or inference(s).

Security device 212 may include one or more specialized security components, such as a dedicated security processor, a Trusted Platform Module (TPM), a TRUSTZONE device, a PLUTON processor, or the like. In various implementations, security device 212 may be used to perform cryptography operations (e.g., generation of key pairs, validation of digital certificates, etc.) and/or it may serve as a hardware RoT for heterogenous computing platform 200 and/or IHS 100.

Modem/wireless controller 213 may be designed to enable wired and wireless communications in any suitable frequency band (e.g., BLUETOOTH or “BT,” WiFi, CDMA, 5G, satellite, etc.), subject to AI-powered optimizations/customizations for improved speeds, reliability, and/or coverage.

Peripherals 214 may include any device coupled to heterogenous computing platform 200 (e.g., sensors 110) through mechanisms other than PCIe interfaces 205. In some cases, peripherals 214 may include interfaces to integrated devices (e.g., built-in microphones, speakers, and/or cameras), wired devices (e.g., external microphones, speakers, and/or cameras, Head-Mounted Devices/Displays or “HMDs,” printers, displays, etc.), and/or wireless devices (e.g., wireless audio headsets, etc.) coupled to IHS 100.

In some implementations, EC 109 may be integrated into heterogenous computing platform 200 of IHS 100. In other implementations EC 109 may be external to the heterogenous computing platform 200 (i.e., the EC 109 residing in its own semiconductor package) but coupled to integrated bridge 216 via an interface (e.g., enhanced SPI or “eSPI”), thus supporting the EC's ability to access the SoC's interconnect fabric 203, including sensor hub 207 and sensor(s) 110. Through this connectivity supported by interconnect fabric 203, EC 109 may directly access and/or operate most or all of devices 201-216, 110 of heterogenous computing platform 200.

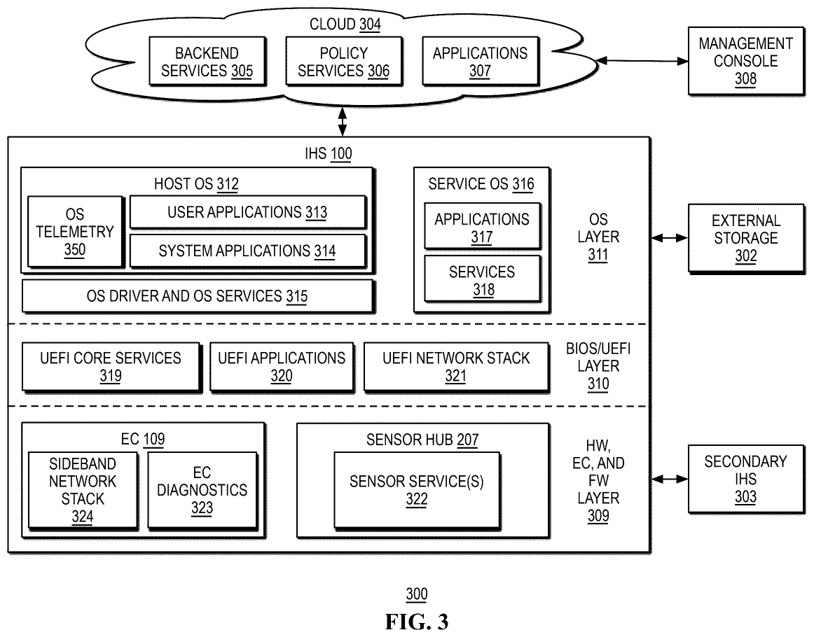

FIG. 3 is a diagram illustrating an example of architecture 300 usable with IHS 100. Particularly, architecture 300 includes IHS 100 (e.g., implementing aspects of IHS 100 and/or platform 200) coupled to storage device 302 (e.g., NVMe, SSD, etc.), secondary or companion IHS 303 (e.g., a smart phone, a laptop, etc.), and cloud or remote services 304. Cloud 304 may include backend or remote services 305, policy services 306, and web applications 307. In some cases, components of cloud 304 may be accessible to IHS 100 and/or secondary IHS 303, and configurable via ITDM management console 308.

IHS 100 may include hardware/EC/firmware layer 309, BIOS/UEFI layer 310, and OS layer 311. Specifically, OS layer 311 includes host OS 312 executed by host processor(s) 101. A variety of software applications may operate within OS 312, where these applications may include user applications 313 and system applications 314. Applications that operate within the OS 312 may also include one or more telemetry applications 350.

OS layer 311 may also include various drivers and other core OS operations, such as the operation of a kernel. As described, various components of heterogenous computing platform 200 may independently run their own OS, such as a Real-Time OS (RTOS) run by an SoC.

Within IHS 100, RTOSs executed by individual components of the heterogenous computing platform 200 are deemed distinct from service OS 316, which includes its own applications 317 and services 318. Hardware device drivers 315 used by host OS 312 and/or by service OSs 316 may support the operation of IHS 100 hardware.

BIOS/UEFI layer 310 may include pre-OS core services 319, pre-OS applications 320, and pre-OS network stack 321 that are each executed by BIOS/UEFI 107. BIOS core services 319 may include operations for identifying and validating the detected hardware components of IHS 100. BIOS applications 320 may include operations for interfacing with certain hardware devices of IHS 100, in particular user input devices. The network stack 321 of BIOS 310 may be utilized during initialization of IHS 100 in support of validation procedures, such as in retrieving reference signatures corresponding to authentic firmware instructions for hardware components of IHS 100.

As illustrated, IHS 100 also includes hardware/EC/firmware layer 309 with EC 109 and sensor hub 207. As described above, EC 109 may implement a variety of procedures for management of individual hardware of IHS 100. EC 109 is configured to execute one or more sensor services 323 that interface with sensor hub 207 in implementing various operations, such response to user-presence determination by the sensor hub 207 that is acted upon by the EC 109 in initiation heightened security protocols. Moreover, EC 109 may interface with some or all individual hardware components/systems of IHS 100 via sideband management channels that are separate from inline communication channels used by host processor(s) 101 and SoCs.

As described above, sensor hub 207 may receive inputs from some or all sensors 110A-N of an IHS 100. Sensor hub 207 may implement a variety of sensor service(s) 322 for communicating with and collecting data from sensors 110A-N. In some embodiments, sensor hub 207 may implement shock detection procedures that may incorporate inputs from inertial and other sensors 110A-N of IHS 100. Shock detection procedures may detect shocks experienced by IHS 100 and may characterize and assess possible damage to IHS 100.

Supply chain management in the context of IHS manufacturing by OEMs presents several challenges, particularly in ensuring the authenticity and quality of components sourced from various suppliers. The complexity of modern supply chains, coupled with the global nature of component manufacturing and distribution, makes maintaining consistent quality and security standards difficult. These issues are exacerbated by the presence of counterfeit or substandard components that can infiltrate the supply chain, leading to potential risks in performance, reliability, and security of the final product.

Current methods for managing supply chain integrity often rely on traditional certification processes and manual verification methods. These approaches, while useful, have significant drawbacks. For instance, traditional certification processes may not provide real-time verification of component authenticity, leading to delays and potential gaps in the supply chain. Additionally, manual verification methods are prone to human error and may not scale effectively with the increasing complexity and volume of components in modern IHSs. Furthermore, existing solutions may not adequately address the need for end-to-end traceability and accountability in the supply chain, leaving room for vulnerabilities and inconsistencies.

Conventional supplier or vendor certificates do not provide mechanisms that provide attestation that their device was made and provisioned for a given OEM. The current approach to authenticating the cryptographic identity of a device is based on a Security Protocol and Data Model (SPDM) certificate as specified by the Distributed Management Task Force (DMTF) in DSP0274, and which only provides attestation that the device was manufactured by a given supplier.

This raises several concerns for an OEM. First, the OEM's customers may source components from unrestricted sources, leading to potential inconsistencies with the OEM's parts requirements. This situation poses significant risks, including the possibility of receiving low-quality or non-genuine parts, which can compromise IHS 100. Such issues not only jeopardize the OEM's reputation but also increase the effort required to support unqualified parts.

Another concern is that a supplier's production may yield different tiers of capability, with significant differences in the early deployment stages, typically within the first six months of a product launch. An OEMs may aim to receive only tier 1 products to meet its own requirements, but there is no guarantee that this behavior is consistently followed. Additionally, channel devices may be purchased outside of the OEM's supply chain, impacting customer perception of quality, field support, maintenance, and ultimately the OEM's margin.

To address these, and other concerns, systems and methods described herein relate to supply chain certificate generation. In various embodiments, these systems and methods may leverage cryptographic techniques to ensure the authenticity and quality of components throughout the supply chain. By integrating a supply chain signature process, the process may guarantee that components meet specific quality and security requirements set by the manufacturer. As such, these systems and methods may enhance the reliability and security of the supply chain and provide a scalable and automated solution for managing component verification and certification.

In some implementations, systems and methods described herein may (a) provide SPDM certificate signing requests and certificate provisioning usable to verify OEM-specific manufacturing, and/or (b) extend the supplier's SPDM certificate with an OEM's encrypted blob or digest. An SPDM certificate may be extended to include an encrypted blob containing OEM-specific information. This extension allows the OEM to verify that the device was manufactured specifically for that OEM and meets its quality, performance, consistency, lifecycle behavior, security, and/or certification requirements, providing an additional layer of assurance and traceability in the supply chain.

Moreover, these systems and methods may enable verification that a device is being manufactured for a given OEM (and not another OEM) by verifying that the device serial number is associated with the given OEM's Purchase Order (PO), and that the given OEM has not previously authenticated the supplier's CSR. A certificate extension may be added to the CSR that contains an encrypted digest of the CSR and other pertinent metadata (e.g., device serial number, model number, PO, certificate serial number, etc.). This provides forensic capability to be used as the need arises to establish that the device was procured as that OEM's component, as opposed to a part purchased outside of the OEM's supply chain.

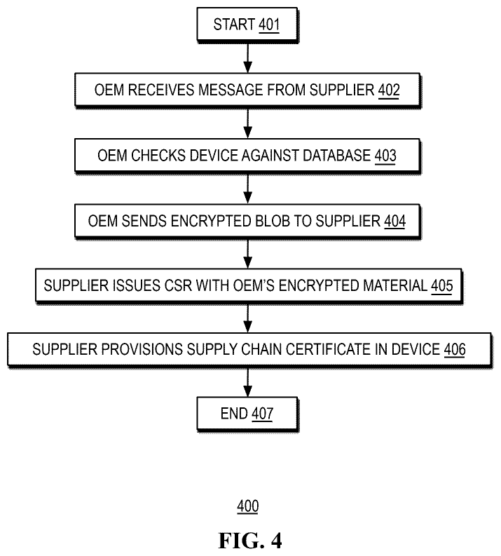

FIG. 4 is a diagram illustrating an example of method 400 for handling supply chain certificates in connection with the manufacturing of IHS 100. In various embodiments, method 400 may be implemented by an OEM and a supplier to ensure the authenticity and quality of components along the supply chain through cryptographic certificates. In this example, an OEM collaborates with a part, device, or component supplier to generate a supply chain certificate. Such a certificate, upon validation, confirms that the part, device, or component was manufactured specifically for the OEM and/or adheres to a defined set of performance or quality standards.

Particularly, method 400 begins at 401. At 402, the OEM may receive an electronic message from the supplier, for example, over a network connection. The message may identify a device, part, or component that is being manufactured by the supplier, and it may include information such as a message ID and other identifying details about the device (e.g., SKU, part number, serial number, etc.).

At 403, the OEM may check the device against a Purchase Order (PO) database or the like. The PO database may contain information related to purchase orders issued by the OEM, including device serial numbers, model numbers, and other pertinent metadata. As such, method 400 may ensure that the device is listed in the database and has not been previously processed.

At 404, the OEM may send an encrypted blob material to the supplier. The encrypted blob may include information such as the device serial number, model number, purchase order number, and/or any other information that enables the OEM to determine that the device was made for it, under a set of performance or quality standards, and/or for a specific OEM customer.

The OEM may use cryptographic techniques to create the encrypted material, ensuring the encrypted material's integrity and security. In some cases, the OEM's encrypted material may itself be a digital certificate.

At 405, the supplier may issue a CSR with the OEM's encrypted blob material. The CSR may include the encrypted material and other information required for the issuance of a digital certificate. The supplier may submit the CSR to a Hardware Security Module (HSM) or Certificate Authority (CA) for signing.

At 406, the supplier may provision or store the cryptographic certificate in the device. This supply chain certificate, issued by the supplier's HSM or CA, may include the OEM's encrypted material, thus providing a mechanism for cryptographic attestation that the device was manufactured specifically for the OEM. Method 400 ends at 407.

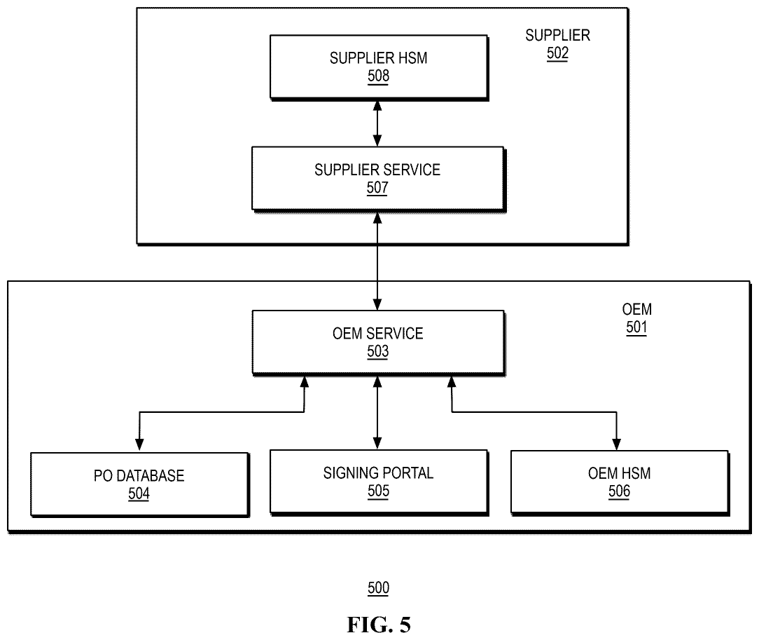

FIG. 5 is a flowchart illustrating an example of system 500 for handling supply chain certificates. In various embodiments, system 500 may be configured to perform one or more operations of method 400, as well as other operations described herein.

Specifically, system 500 may include OEM 501 and supplier 502. OEM 501 includes OEM service 503, PO database 504, signing portal 505, and OEM HSM 506. Meanwhile, supplier 502 may include supplier service 507 and supplier HSM 508.

OEM service 503 may interface with PO database 504, signing portal 505, and OEM HSM 506. OEM service 503 may manage the interactions between these components to ensure the authenticity and quality of components along the supply chain. PO database 504 may store information related to purchase orders issued by the OEM 501, including device serial numbers, model numbers, and other pertinent metadata. Signing portal 505 may facilitate the signing of digital certificates, while OEM HSM 506 may provide secure cryptographic operations for OEM 501.

Supplier service 507 may interface with the supplier HSM 508 and communicate with OEM service 503. Supplier service 507 may manage interactions between supplier 502 and OEM 501, ensuring that these components meet the specific quality and security requirements set by OEM 501. Supplier HSM 508 may provide secure cryptographic operations for the supplier 502.

As such, system 500 may enable OEM 501 and supplier 502 to collaborate in generating and managing supply chain certificates, for example, by implementing method 400. This collaboration ensures that the components are manufactured specifically for the OEM 501 and meet the defined performance, security, or quality standards.

In various embodiments, a supply chain certificate may be built using either an OEM's encrypted blob or an OEM's digital certificate. For example, when using an OEM's encrypted blob, the OEM generates an encrypted blob that contains specific information about the device, such as the device serial number, model number, and purchase order number. The encrypted blob is not itself a digital certificate but contains critical information for verifying the device's authenticity and compliance with the OEM's quality and security requirements. This encrypted blob is then sent to the supplier, who produces a cryptographic, supply chain certificate that includes the OEM's encrypted blob. The supply chain certificate is then provisioned in slot 0 of the SPDM certificate slot on the device.

In contrast, when using an OEM's digital certificate, the OEM generates a digital certificate that includes specific information about the device. This digital certificate is sent to the supplier, who in turn produces a supply chain certificate which includes the OEM's digital certificate. This supply chain certificate is then provisioned in slot 1 of the SPDM certificate slot on the device.

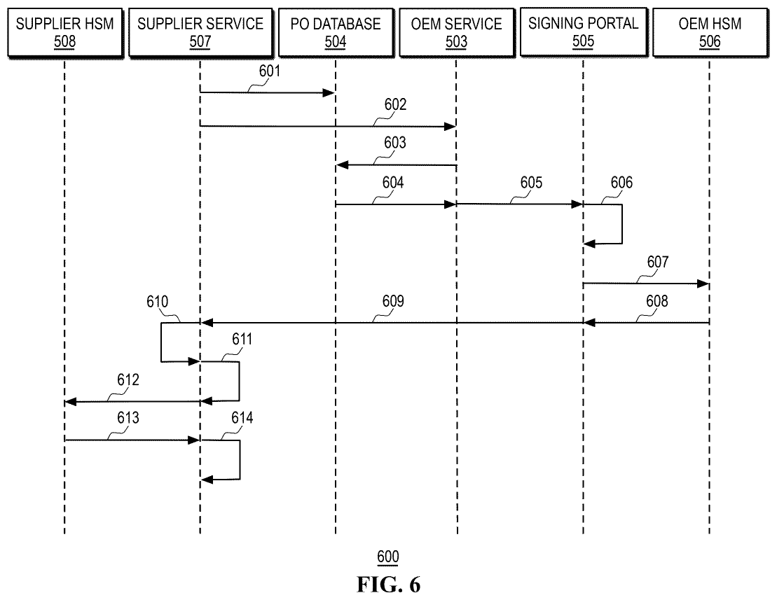

To illustrate the OEM's encrypted blob techniques, FIG. 6 shows a diagram illustrating an example of process flow 600 for handling supply chain certificates. In various embodiments, process flow 600 may be performed by components 501-508 of FIG. 5 during execution of method 400.

In this case, supplier service 507 initiates the process by sending message 601 to PO database 504 to update it with unique parameters for each device being produced. At 602, supplier service 507 sends OEM service 503 a message with a unique message ID, notifying the OEM that there is an impending SPDM certificate being constructed for a device. This message may also indicate, to the OEM, that it needs to create an encrypted blob or material for the device.

At 603, OEM service 503 checks PO database 504 based on the message ID to ensure: (a) that device is in PO database 504; and (b) the OEM has not previously processed a request for the same device or message ID. If these two items are verified, PO database 504 may send message 604 to OEM service 503 indicating that the supplier's blob request is valid.

If so, at 605, OEM service 503 may send a message to signing portal 505 to create an encrypted blob. At 606, signing portal 505 may create blob metadata. The blob metadata may include the message ID, the device's serial number, model number, PO and other OEM material.

At 607, signing portal 505 may send the blob metadata to OEM HSM 506 encrypt and sign the custom extension with an asymmetric key. This resulting encrypted blob may provide the OEM with forensic capabilities that ensure the device was manufactured and tested to the OEM's specifications.

At 608, OEM HSM 506 may return a custom extension with the encrypted blob to signing portal 505. At 609, signing portal 505 may send the encrypted blob to supplier service 507 along with the original message ID. At 610, supplier service 507 may verify the message ID is for the intended device. At 611, supplier service 507 may create a CSR that includes the encrypted blob in the certificate.

At 612, supplier service 507 may send the CSR to supplier HSM 508. In response, at 613, supplier HSM 508 may return a signed supply chain certificate to supplier service 507. At 614, supplier service 507 may verify the signed supply chain certificate with a public key and, if validated, it may provision or store the signed supply chain certificate in slot 0 of the device's SPDM prior to shipping the device to the OEM.

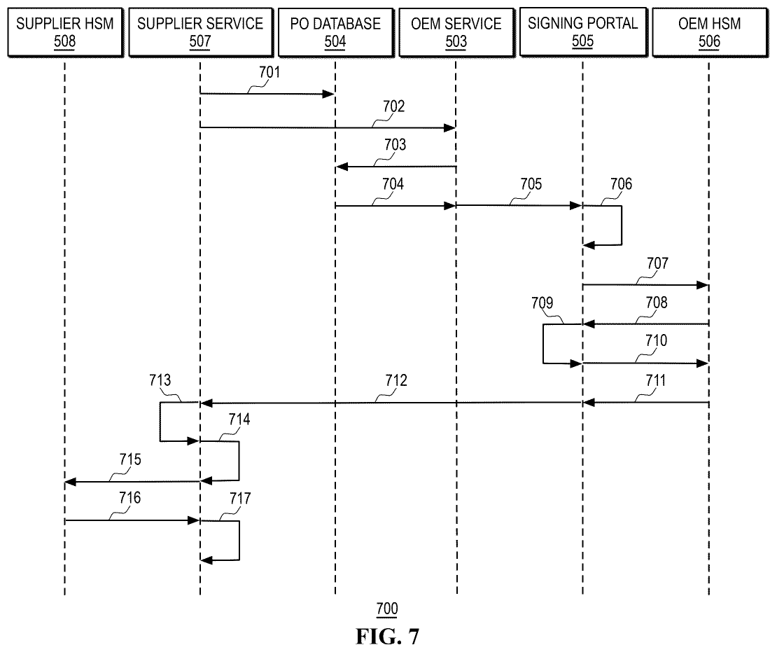

Now to illustrate the OEM's digital certificate techniques, FIG. 7 shows a diagram illustrating an example of process flow 700 for handling supply chain certificates. As before, supplier service 507 initiates the process by sending message 701 to PO database 504 to update it with unique parameters for each device being produced. At 702, supplier service 507 sends OEM service 503 a message with a unique message ID, notifying the OEM that there is an impending SPDM certificate being constructed for a device. Unlike in process flow 600, however, here message 702 may indicate, to the OEM, that it needs to create a digital certificate for the device.

At 703, OEM service 503 checks PO database 504 based on the message ID to ensure: (a) that device is in PO database 504; and (b) the OEM has not previously processed a request for the same device or message ID. If these two items are verified, PO database 504 may send message 704 to OEM service 503 indicating that the supplier's certificate request is valid.

If so, at 705, OEM service 503 may send a certificate creation request to signing portal 505 to create a digital certificate. At 706, signing portal 505 may create blob metadata. The blob metadata may include the message ID, the device's serial number, model number, PO and other OEM material.

At 707, signing portal 505 may send the blob metadata to OEM HSM 506 encrypt it. At 708, OEM HSM 506 may send the encrypted blob to signing portal 505. At 709, signing portal 506 creates an X.509 certificate with the encrypted blob. At 710, signing portal 506 sends the X.509 certificate to OEM HSM 506 to be signed, and at 711, OEM HSM 506 returns a signed X.509 certificate to signing portal 505.

At 712, signing portal 505 may send the signed X.509 certificate to supplier service 507 along with the original message ID. At 713, supplier service 507 may verify the certificate sent by the OEM's signing portal 505 matches the message ID for the device. At 714, supplier service 507 may generate a CSR inclusive of the OEM's signed X.509 certificate (a leaf certificate) as an extension.

At 715, supplier service 507 may send the CSR to supplier HSM 508 for certificate signing. In response, at 716, supplier HSM 508 may return a signed supply chain certificate to supplier service 507. At 717, supplier service 507 may verify that the extension certificate device's serial number matches the physical device's serial number and, if validated, it may provision or store the signed supply chain certificate in slot 1 of the device's SPDM certificate slot prior to shipping the device to the OEM.

Regardless of whether process flows 600 are 700 (or some variation thereof) are used, when the need arises, the signed supply chain certificate can be decrypted and used to verify supply chain authenticity.

To ensure the integrity and authenticity of the certificate, several attributes may be verified. For example, the device's serial number may be checked to confirm that the supply chain certificate is intended for the device being provisioned. Next, a Subject Key Identifier (SKID) in the supply chain certificate chain may be checked against the public key for the device. If the SKID matches the public key for the specific device being provisioned, the supply chain certificate may be accepted. Additionally, the verification process may ensure that the OEM's extension (e.g., the OEM's encrypted blob or digital certificate) has been added to the supply chain certificate. After the supply chain certificate is signed and provisioned, the full certificate chain may be validated before the device leaves the supplier's factory, for instance, following the SPDM challenge response protocol.

In some embodiments, the supply chain of a single device may involve multiple tiers of suppliers. For example, a supplier may be responsible for producing a finished device, while a secondary supplier may produce a subcomponent of that device. In such a case, the first supplier may be configured to forward the OEM's encrypted blob or digital certificate, which contains OEM-specific information, to the secondary supplier. The secondary supplier may then use this encrypted blob to generate another CSR for the subcomponent it produces. This may ensure that the part produced by the secondary supplier is also verified and authenticated according to the OEM's quality and security requirements, thereby maintaining the integrity and traceability of the entire supply chain.

Additionally, or alternatively, the supply chain certificate may specifically indicate that the device was manufactured for a particular customer of the OEM. This feature may enable the system to not only verify that a device was made for the OEM but also to ensure that it meets the specific requirements or specifications set by a particular customer of the OEM. Such an added layer of verification provides assurance that the device adheres to the quality and performance standards expected by the OEM's customer, thereby enhancing the reliability and trustworthiness of the supply chain. This capability may be particularly useful in scenarios where customers have unique or stringent requirements for the components they receive, ensuring that these requirements are met and documented through the supply chain certificate.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein regarding specific embodiments are not intended to be construed as a critical, required, or essential feature or element of any or all the claims.

1. An Information Handling System (IHS), comprising:
a processor; and
a memory coupled to the processor, the memory having program instructions stored thereon that, upon execution, cause the IHS to:
receive a message from a supplier, wherein the message identifies a device; and
in response to verification of the device against a Purchase Order (PO) database of an Original Equipment Manufacturer (OEM), send encrypted material to the supplier, wherein the supplier is configured to generate a Certificate Signing Request (CSR) for the device comprising the encrypted material.

2. The IHS of claim 1, wherein to verify the device against the PO database, the program instructions, upon execution, further cause the IHS to determine the device has not been previously processed.

3. The IHS of claim 1, wherein the encrypted material comprises at least one of: a device serial number, a model number, or a PO number.

4. The IHS of claim 1, wherein the supplier is configured to receive a digital certificate in response to the CSR.

5. The IHS of claim 1, wherein the message comprises a message ID indicating an impending digital certificate for the device.

6. The IHS of claim 5, wherein attestation of the digital certificate indicates the device was made for the OEM.

7. The IHS of claim 5, wherein attestation of the digital certificate indicates the device was made for a customer of the OEM.

8. The IHS of claim 5, wherein the digital certificate comprises a Security Protocol and Data Model (SPDM) certificate.

9. The IHS of claim 8, wherein the supplier is configured to store the SPDM certificate in slot 0 of the device.

10. The IHS of claim 1, wherein the supplier comprises a first supplier and a second supplier, the first supplier produces the device, the second supplier produces a device part, the first supplier is configured to forward the encrypted blob to the second supplier, and the second supplier is configured to generate another CSR for the part.

11. A method, comprising:
receiving a message from a supplier, wherein the message identifies a device; and
in response to verification of the device against a Purchase Order (PO) database of an Original Equipment Manufacturer (OEM), transmitting an OEM's digital certificate to the supplier, wherein the supplier is configured to generate a Certificate Signing Request (CSR) for the device comprising the OEM's digital certificate.

12. The method of claim 11, wherein the message comprises a message ID indicating an impending Security Protocol and Data Model (SPDM) certificate for the device.

13. The method of claim 11, wherein the digital certificate comprises at least one of: a device serial number, a model number, or a PO number.

14. The method of claim 11, wherein the supplier is configured to receive a device's digital certificate in response to the CSR.

15. The method of claim 11, wherein the supplier is configured to store the device's digital certificate in slot 1 of the device.

16. A hardware memory device having program instructions stored thereon that, upon execution by a processor of an Information Handling System (IHS), cause the IHS to:
send a message to an OEM, wherein the message identifies a device; and
receive encrypted material from an Original Equipment Manufacturer (OEM) in response to the OEM's verification of the device against a Purchase Order (PO) database.

17. The hardware memory device of claim 16, wherein the encrypted material comprises a digital certificate issued by the OEM.

18. The hardware memory device of claim 16, wherein the program instructions, upon execution by the processor, cause the IHS to generate a Certificate Signing Request (CSR) for the device comprising the encrypted material.

19. The hardware memory device of claim 16, wherein the processor is part of a heterogenous computing platform selected from the group consisting of: a System-On-Chip (SoC), a Field-Programmable Gate Array (FPGA), and an Application-Specific Integrated Circuit (ASIC).

20. The hardware memory device of claim 19, wherein the heterogenous computing platform comprises a Reduced Instruction Set Computer (RISC) processor coupled to the EC via an interconnect, and wherein the interconnect comprises at least one of: an Advanced Microcontroller Bus Architecture (AMBA) bus, a QuickPath Interconnect (QPI) bus, or a HyperTransport (HT) bus.
